(19) United States
(12) Patent Application Publication
(10) Pub. No.: US 2019/0123983 A1
(43) Pub. Date: Apr. 25, 2019

(54) DATA INTEGRATION AND USER APPLICATION FRAMEWORK

(71) Applicant: Cisco Technology, Inc., San Jose, CA (US)

(72) Inventors: Supreeth Rao, Cupertino, CA (US); Navindra Yadav, Cupertino, CA (US); Prasannakumar Jobigenahally Malleshaiah, Sunnyvale, CA (US); Darshan Shrinath Purandare, Fremont, CA (US); Aiyesha Ma, San Francisco, CA (US); Aria Rahadian, San Jose, CA (US); Umamaheswaran Arumugam, San Jose, CA (US); Xuan Zou, Sunnyvale, CA (US)

(21) Appl. No.: 15/793,473

(22) Filed: Oct. 25, 2017

(51) Int. Cl. H04L 12/26; H04W 28/08; H04L 12/803

(52) U.S. Cl. CPC H04L 43/062; H04L 47/125; H04W 28/08; H04L 43/026

(57) ABSTRACT

Systems, methods, and computer-readable media for correlating gathered network traffic data and analytics with external data for purposes of managing a cluster of nodes in a network. In some embodiments, a system can identify a cluster of nodes in a network. Network traffic data for the cluster of nodes in the network can be collected based on traffic flowing through the cluster of nodes using a group of sensors implemented in the network. The system can generate analytics for the cluster of nodes in the network using the collected network traffic data. The analytics can be correlated with external data to create correlated external analytics for use in controlling operation of the cluster of nodes in the network.

### TECHNICAL FIELD

The present technology pertains to correlating data generated in monitoring clusters of nodes in a network with external data for use in controlling operation of the clusters of nodes in the network.

### BACKGROUND

In a network environment, sensors can be placed at various devices or elements in the network to collect flow data and network statistics from different locations. In particular sensors can be deployed in a network to collect network traffic data related to nodes or clusters of nodes operating in the network. The collected data from the sensors can be analyzed to monitor and troubleshoot the network. The data collected by the sensors can provide valuable details about the status, security, or performance of the network, as well as any network elements. Currently, such collected data and analytics generated from the collected data are only used and analyzed in a closed system. Specifically, users are not exposed to or otherwise allowed to access all of the underlying collected data and generated analytics. This limits the users' abilities in customizing or using the collected data and generating analytics for their own purposes. Additionally, as all of the collected data and generated analytics are not exposed, the data and analytics cannot be correlated or analyzed with external data. This leads to deficiencies in capitalizing on potential insights into a network and increased levels of control of the network that the collected data and generated analytics can provide when correlated and analyzed with external data.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example network traffic monitoring system;

FIG. 2 illustrates an example of a network environment;

FIG. 3 depicts a diagram of an example network traffic data user access system 300;

FIG. 4 illustrates a flowchart for an example method of correlating network traffic data, analytics and external data for use in controlling operation of a network;

FIG. 5 depicts a diagram of an example network traffic-based network controller;

FIG. 6 illustrates an example network device in accordance with various embodiments; and

FIG. 7 illustrates an example computing device in accordance with various embodiments.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### Overview

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

A method can include identifying a cluster of nodes in a network. Network traffic data for the cluster of nodes can be collected based on network traffic flowing through the cluster of nodes using a group of sensors implemented in the network. Analytics for the cluster of nodes can be generated using the collected network traffic data. The collected network traffic data can then be correlated with external data to create external analytics for use in controlling operation of the cluster of nodes in the network.

A system can identify a cluster of nodes in a network. Additionally, the system can collect network traffic data for the cluster of nodes including host and endpoint data for the cluster of nodes based on network traffic flowing through the cluster of nodes using a group of sensors implemented in the network. Using the network traffic data, including the host and endpoint data, the system can generate analytics for the cluster of nodes in the network. The system can correlate the analytics with external data to create correlated external analytics for use in controlling operation of the cluster of nodes in the network.

A system can identify a cluster of nodes in a network. Additionally, the system can collect network traffic data for the cluster of nodes based on network traffic flowing through the cluster of nodes using a group of sensors implemented in the network. Using the network traffic data, the system can generate analytics for the cluster of nodes in the network. The system can correlate the analytics with external data including a blacklist to create correlated external analytics for use in controlling operation of the cluster of nodes in the network.

### Example Embodiments

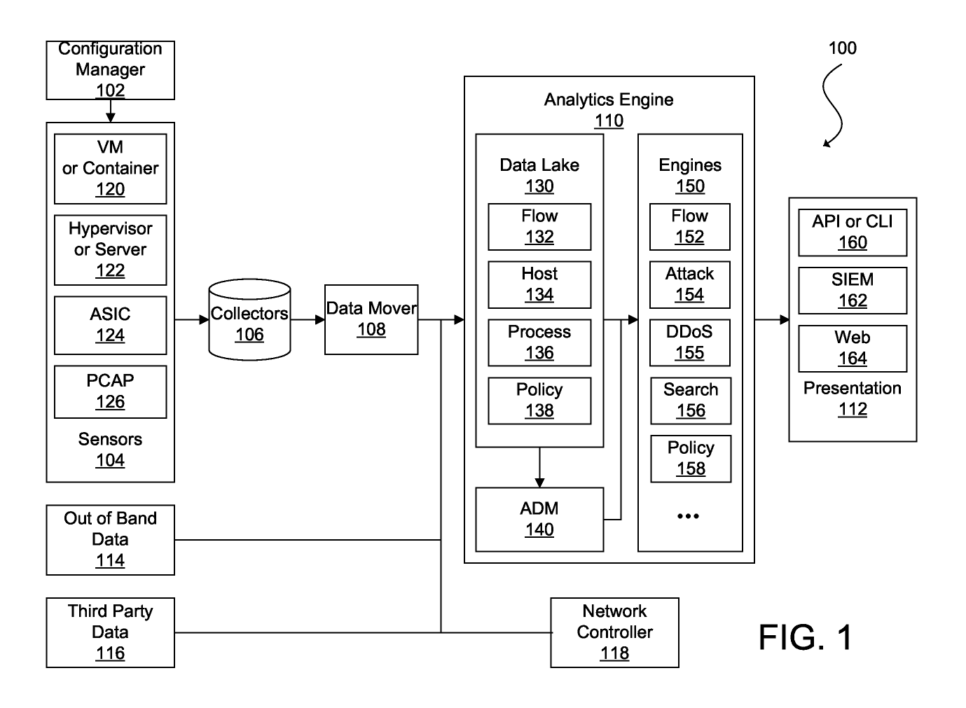

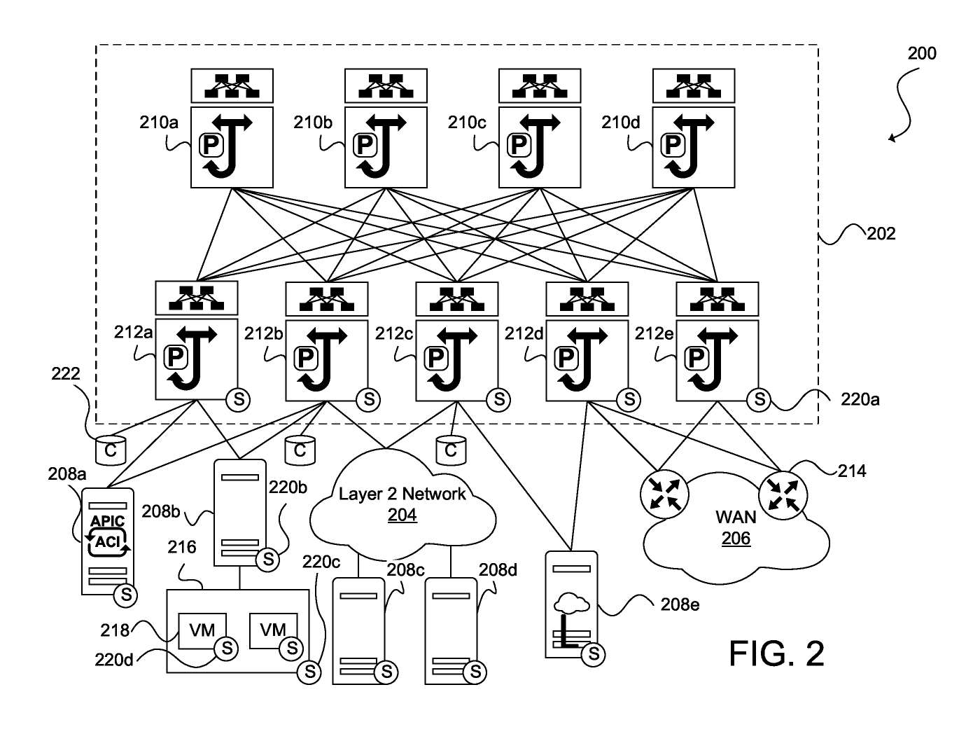

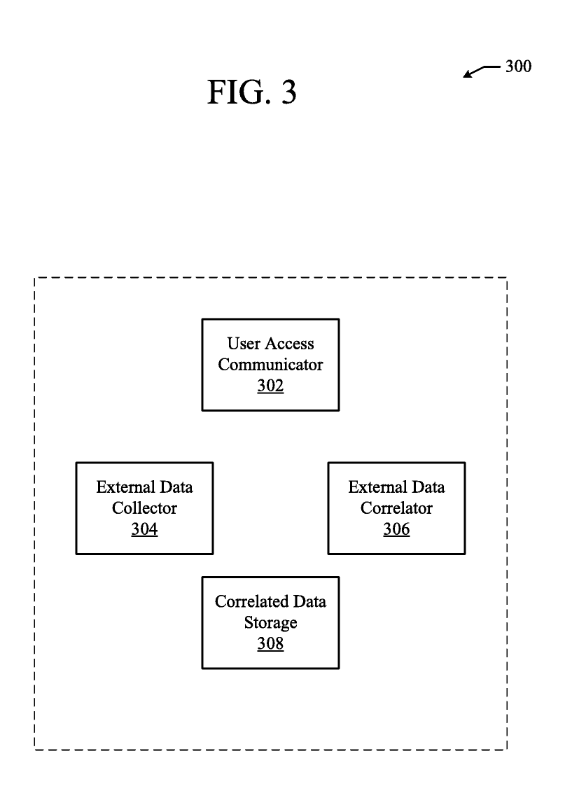

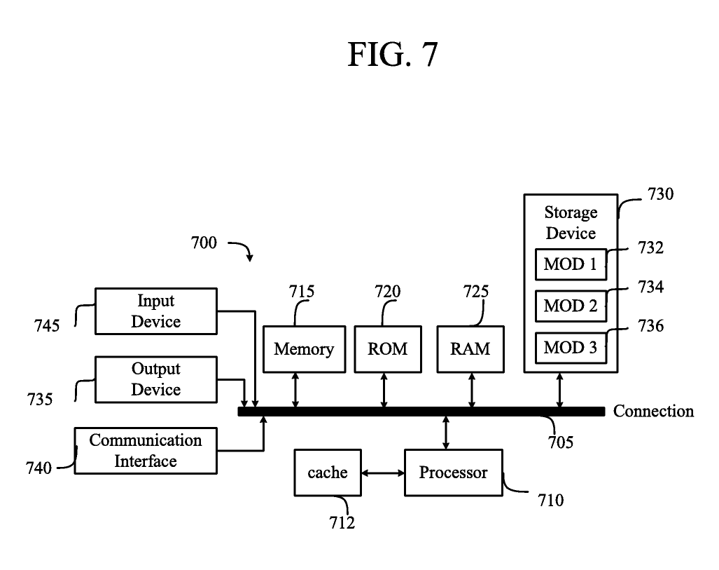

The disclosed technology addresses the need in the art for providing user access to gathered network traffic data and analytics generated from such data. Additionally, the disclosed technology addresses the need in the art for correlating external data with gathered network traffic data and analytics generated for such data, for use in controlling operation of a cluster of nodes in a network. The present technology involves system, methods, and computer-readable media for providing user access to gathered network traffic data and analytics. Additionally, the present technology involves systems, methods, and computer-readable media for correlating network traffic data and analytics generated from the data with external data for use in controlling operation of a cluster of nodes in a network. The present technology will be described in the following disclosure as follows. The discussion begins with an introductory discussion of network traffic data collection and a description of an example network traffic monitoring system and an example network environment, as shown in FIGS. 1 and 2. A discussion of example systems and methods for correlating network traffic data and analytics with external data for controlling operation of a cluster of nodes in a network, as shown in FIGS. 3-5, will then follow. A discussion of example network devices and computing devices, as illustrated in FIGS. 7 and 8, will then follow. The disclosure now turns to an introductory discussion of network sensor data collection based on network traffic flows and clustering of nodes in a network for purposes of collecting data based on network traffic flows.

Sensors implemented in networks are traditionally limited to collecting packet data at networking devices. In some embodiments, networks can be configured with sensors at multiple points, including on networking devices (e.g., switches, routers, gateways, firewalls, deep packet inspectors, traffic monitors, load balancers, etc.), physical servers, hypervisors or shared kernels, virtual partitions (e.g., VMs or containers), and other network elements. This can provide a more comprehensive view of the network. Further, network traffic data (e.g., flows) can be associated with, or otherwise include, host and/or endpoint data (e.g., host/endpoint name, operating system, CPU usage, network usage, disk space, logged users, scheduled jobs, open files, information regarding files stored on a host/endpoint, etc.), process data (e.g., process name, ID, parent process ID, path, CPU utilization, memory utilization, etc.), user data (e.g., user name, ID, login time, etc.), and other collectible data to provide more insight into network activity.

Sensors implemented in a network at multiple points can be used to collect data for nodes grouped together into a cluster. Nodes can be clustered together, or otherwise a cluster of nodes can be identified using one or a combination of applicable network operation factors. For example, endpoints performing similar workloads, communicating with a similar set of endpoints or networking devices, having similar network and security limitations (i.e., policies), and sharing other attributes can be clustered together.

In some embodiments, a cluster can be determined based on early fusion in which feature vectors of each node comprise the union of individual feature vectors across multiple domains.

For example, a feature vector can include a packet header-based feature (e.g., destination network address for a flow, port, etc.) concatenated to an aggregate flow-based feature (e.g., the number of packets in the flow, the number of bytes in the flow, etc.). A cluster can then be defined as a set of nodes whose respective concatenated feature vectors are determined to exceed specified similarity thresholds (or fall below specified distance thresholds).

In some embodiments, a cluster can be defined based on late fusion in which each node can be represented as multiple feature vectors of different data types or domains. In such systems, a cluster can be a set of nodes whose similarity (and/or distance measures) across different domains, satisfy specified similarity (and/or distance) conditions for each domain. For example, a first node can be defined by a first network information-based feature vector and a first process-based feature vector while a second node can be defined by a second network information-based feature vector and a second process-based feature vector. The nodes can be determined to form a cluster if their corresponding network-based feature vectors are similar to a specified degree and their corresponding process-based feature vectors are only a specified distance apart.

Referring now to the drawings, FIG. 1 is an illustration of a network traffic monitoring system 100 in accordance with an embodiment. The network traffic monitoring system 100 can include a configuration manager 102, sensors 104, a collector module 106, a data mover module 108, an analytics engine 110, and a presentation module 112. In FIG. 1, the analytics engine 110 is also shown in communication with out-of-band data sources 114, third party data sources 116, and a network controller 118.

The configuration manager 102 can be used to provision and maintain the sensors 104, including installing sensor software or firmware in various nodes of a network, configuring the sensors 104, updating the sensor software or firmware, among other sensor management tasks. For example, the sensors 104 can be implemented as virtual partition images (e.g., virtual machine (VM) images or container images), and the configuration manager 102 can distribute the images to host machines. In general, a virtual partition can be an instance of a VM, container, sandbox, or other isolated software environment. The software environment can include an operating system and application software. For software running within a virtual partition, the virtual partition can appear to be, for example, one of many servers or one of many operating systems executed on a single physical server. The configuration manager 102 can instantiate a new virtual partition or migrate an existing partition to a different physical server. The configuration manager 102 can also be used to configure the new or migrated sensor.

The configuration manager 102 can monitor the health of the sensors 104. For example, the configuration manager 102 can request for status updates and/or receive heartbeat messages, initiate performance tests, generate health checks, and perform other health monitoring tasks. In some embodiments, the configuration manager 102 can also authenticate the sensors 104. For instance, the sensors 104 can be assigned a unique identifier, such as by using a one-way hash function of a sensor's basic input/out system (BIOS) universally unique identifier (UUID) and a secret key stored by the configuration image manager 102. The UUID can be a large number that can be difficult for a malicious sensor or other device or component to guess. In some embodiments, the configuration manager 102 can keep the sensors 104 up to date by installing the latest versions of sensor software and/or applying patches. The configuration manager 102 can obtain these updates automatically from a local source or the Internet.

The sensors 104 can reside on various nodes of a network, such as a virtual partition (e.g., VM or container) 120; a hypervisor or shared kernel managing one or more virtual partitions and/or physical servers 122, an application-specific integrated circuit (ASIC) 124 of a switch, router, gateway, or other networking device, or a packet capture (pcap) 126 appliance (e.g., a standalone packet monitor, a device connected to a network devices monitoring port, a device connected in series along a main trunk of a datacenter, or similar device), or other element of a network. The sensors 104 can monitor network traffic between nodes, and send network traffic data and corresponding data (e.g., host data, process data, user data, etc.) to the collectors 108 for storage. For example, the sensors 104 can sniff packets being sent over its hosts' physical or virtual network interface card (NIC), or individual processes can be configured to report network traffic and corresponding data to the sensors 104. Incorporating the sensors 104 on multiple nodes and within multiple partitions of some nodes of the network can provide for robust capture of network traffic and corresponding data from each hop of data transmission. In some embodiments, each node of the network (e.g., VM, container, or other virtual partition 120, hypervisor, shared kernel, or physical server 122, ASIC 124, pcap 126, etc.) includes a respective sensor 104. However, it should be understood that various software and hardware configurations can be used to implement the sensor network 104.

As the sensors 104 capture communications and corresponding data, they can continuously send network traffic data to the collectors 108. The network traffic data can include metadata relating to a packet, a collection of packets, a flow, a bidirectional flow, a group of flows, a session, or a network communication of another granularity. That is, the network traffic data can generally include any information describing communication on all layers of the Open Systems Interconnection (OSI) model. For example, the network traffic data can include source/destination MAC address, source/destination IP address, protocol, port number, etc. In some embodiments, the network traffic data can also include summaries of network activity or other network statistics such as number of packets, number of bytes, number of flows, bandwidth usage, response time, latency, packet loss, jitter, and other network statistics.

The sensors 104 can also determine additional data, included as part of gathered network traffic data, for each session, bidirectional flow, flow, packet, or other more granular or less granular network communication. The additional data can include host and/or endpoint information, virtual partition information, sensor information, process information, user information, tenant information, application information, network topology, application dependency mapping, cluster information, or other information corresponding to each flow.

In some embodiments, the sensors 104 can perform some preprocessing of the network traffic and corresponding data before sending the data to the collectors 108. For example, the sensors 104 can remove extraneous or duplicative data or they can create summaries of the data (e.g., latency, number of packets per flow, number of bytes per flow, number of flows, etc.). In some embodiments, the sensors 104 can be configured to only capture certain types of network information and disregard the rest. In some embodiments, the sensors 104 can be configured to capture only a representative sample of packets (e.g., every 1,000th packet or other suitable sample rate) and corresponding data.

Since the sensors 104 can be located throughout the network, network traffic and corresponding data can be collected from multiple vantage points or multiple perspectives in the network to provide a more comprehensive view of network behavior. The capture of network traffic and corresponding data from multiple perspectives rather than just at a single sensor located in the data path or in communication with a component in the data path, allows the data to be correlated from the various data sources, which can be used as additional data points by the analytics engine 110. Further, collecting network traffic and corresponding data from multiple points of view ensures more accurate data is captured. For example, a conventional sensor network can be limited to sensors running on external-facing network devices (e.g., routers, switches, network appliances, etc.) such that east-west traffic, including VM-to-VM or container-to-container traffic on a same host, may not be monitored. In addition, packets that are dropped before traversing a network device or packets containing errors cannot be accurately monitored by the conventional sensor network. The sensor network 104 of various embodiments substantially mitigates or eliminates these issues altogether by locating sensors at multiple points of potential failure. Moreover, the network traffic monitoring system 100 can verify multiple instances of data for a flow (e.g., source endpoint flow data, network device flow data, and endpoint flow data) against one another.

In some embodiments, the network traffic monitoring system 100 can assess a degree of accuracy of flow data sets from multiple sensors and utilize a flow data set from a single sensor determined to be the most accurate and/or complete. The degree of accuracy can be based on factors such as network topology (e.g., a sensor closer to the source can be more likely to be more accurate than a sensor closer to the destination), a state of a sensor or a node hosting the sensor (e.g., a compromised sensor/node can have less accurate flow data than an uncompromised sensor/node), or flow data volume (e.g., a sensor capturing a greater number of packets for a flow can be more accurate than a sensor capturing a smaller number of packets).

In some embodiments, the network traffic monitoring system 100 can assemble the most accurate flow data set and corresponding data from multiple sensors. For instance, a first sensor along a data path can capture data for a first packet of a flow but can be missing data for a second packet of the flow while the situation is reversed for a second sensor along the data path. The network traffic monitoring system 100 can assemble data for the flow from the first packet captured by the first sensor and the second packet captured by the second sensor.

As discussed, the sensors 104 can send network traffic and corresponding data to the collectors 106. In some embodiments, each sensor can be assigned to a primary collector and a secondary collector as part of a high availability scheme. If the primary collector fails or communications between the sensor and the primary collector are not otherwise possible, a sensor can send its network traffic and corresponding data to the secondary collector. In other embodiments, the sensors 104 are not assigned specific collectors but the network traffic monitoring system 100 can determine an optimal collector for receiving the network traffic and corresponding data through a discovery process. In such embodiments, a sensor can change where it sends it network traffic and corresponding data if its environments changes, such as if a default collector fails or if the sensor is migrated to a new location and it would be optimal for the sensor to send its data to a different collector. For example, it can be preferable for the sensor to send its network traffic and corresponding data on a particular path and/or to a particular collector based on latency, shortest path, monetary cost (e.g., using private resources versus a public resources provided by a public cloud provider), error rate, or some combination of these factors. In other embodiments, a sensor can send different types of network traffic and corresponding data to different collectors. For example, the sensor can send first network traffic and corresponding data related to one type of process to one collector and second network traffic and corresponding data related to another type of process to another collector.

The collectors 106 can be any type of storage medium that can serve as a repository for the network traffic and corresponding data captured by the sensors 104. In some embodiments, data storage for the collectors 106 is located in an in-memory database, such as dashDB from IBM®, although it should be appreciated that the data storage for the collectors 106 can be any software and/or hardware capable of providing rapid random access speeds typically used for analytics software. In various embodiments, the collectors 106 can utilize solid state drives, disk drives, magnetic tape drives, or a combination of the foregoing according to cost, responsiveness, and size requirements. Further, the collectors 106 can utilize various database structures such as a normalized relational database or a NoSQL database, among others.

In some embodiments, the collectors 106 can only serve as network storage for the network traffic monitoring system 100. In such embodiments, the network traffic monitoring system 100 can include a data mover module 108 for retrieving data from the collectors 106 and making the data available to network clients, such as the components of the analytics engine 110. In effect, the data mover module 108 can serve as a gateway for presenting network-attached storage to the network clients. In other embodiments, the collectors 106 can perform additional functions, such as organizing, summarizing, and preprocessing data. For example, the collectors 106 can tabulate how often packets of certain sizes or types are transmitted from different nodes of the network. The collectors 106 can also characterize the traffic flows going to and from various nodes. In some embodiments, the collectors 106 can match packets based on sequence numbers, thus identifying traffic flows and connection links. As it can be inefficient to retain all data indefinitely in certain circumstances, in some embodiments, the collectors 106 can periodically replace detailed network traffic data with consolidated summaries. In this manner, the collectors 106 can retain a complete dataset describing one period (e.g., the past minute or other suitable period of time), with a smaller dataset of another period (e.g., the previous 2-10 minutes or other suitable period of time), and progressively consolidate network traffic and corresponding data of other periods of time (e.g., day, week, month, year, etc.). In some embodiments, network traffic and corresponding data for a set of flows identified as normal or routine can be winnowed at an earlier period of time while a more complete data set can be retained for a lengthier period of time for another set of flows identified as anomalous or as an attack.

The analytics engine 110 can generate analytics using data collected by the sensors 104. Analytics generated by the analytics engine 110 can include applicable analytics of nodes or a cluster of nodes operating in a network. For example, analytics generated by the analytics engine 110 can include one or a combination of information related to flows of data through nodes, detected attacks on a network or nodes of a network, applications at nodes or distributed across the nodes, application dependency mappings for applications at nodes, policies implemented at nodes, and actual policies enforced at nodes.

Computer networks can be exposed to a variety of different attacks that expose vulnerabilities of computer systems in order to compromise their security. Some network traffic can be associated with malicious programs or devices. The analytics engine 110 can be provided with examples of network states corresponding to an attack and network states corresponding to normal operation. The analytics engine 110 can then analyze network traffic and corresponding data to recognize when the network is under attack. In some embodiments, the network can operate within a trusted environment for a period of time so that the analytics engine 110 can establish a baseline of normal operation. Since malware is constantly evolving and changing, machine learning can be used to dynamically update models for identifying malicious traffic patterns.

In some embodiments, the analytics engine 110 can be used to identify observations which differ from other examples in a dataset. For example, if a training set of example data with known outlier labels exists, supervised anomaly detection techniques can be used. Supervised anomaly detection techniques utilize data sets that have been labeled as normal and abnormal and train a classifier. In a case in which it is unknown whether examples in the training data are outliers, unsupervised anomaly techniques can be used. Unsupervised anomaly detection techniques can be used to detect anomalies in an unlabeled test data set under the assumption that the majority of instances in the data set are normal by looking for instances that seem to fit to the remainder of the data set.

The analytics engine 110 can include a data lake 130, an application dependency mapping (ADM) module 140, and elastic processing engines 150. The data lake 130 is a large-scale storage repository that provides massive storage for various types of data, enormous processing power, and the ability to handle nearly limitless concurrent tasks or jobs. In some embodiments, the data lake 130 is implemented using the Hadoop® Distributed File System (HDFS™) from Apache® Software Foundation of Forest Hill, Md. HDFS™ is a highly scalable and distributed file system that can scale to thousands of cluster nodes, millions of files, and petabytes of data. HDFS™ is optimized for batch processing where data locations are exposed to allow computations to take place where the data resides. HDFS™ provides a single namespace for an entire cluster to allow for data coherency in a write-once, read-many access model. That is, clients can only append to existing files in the node. In HDFS™, files are separated into blocks, which are typically 64 MB in size and are replicated in multiple data nodes. Clients access data directly from data nodes.

In some embodiments, the data mover 108 receives raw network traffic and corresponding data from the collectors 106 and distributes or pushes the data to the data lake 130. The data lake 130 can also receive and store out-of-band data 114, such as statuses on power levels, network availability, server performance, temperature conditions, cage door positions, and other data from internal sources, and third party data 116, such as security reports (e.g., provided by Cisco® Systems, Inc. of San Jose, Calif., Arbor Networks® of Burlington, Mass., Symantec® Corp. of Sunnyvale, Calif., Sophos® Group plc of Abingdon, England, Microsoft® Corp. of Seattle, Wash., Verizon® Communications, Inc. of New York, N.Y., among others), geolocation data, IP watch lists, Whois data, configuration management database (CMDB) or configuration management system (CMS) as a service, and other data from external sources. In other embodiments, the data lake 130 can instead fetch or pull raw traffic and corresponding data from the collectors 106 and relevant data from the out-of-band data sources 114 and the third party data sources 116. In yet other embodiments, the functionality of the collectors 106, the data mover 108, the out-of-band data sources 114, the third party data sources 116, and the data lake 130 can be combined. Various combinations and configurations are possible as would be known to one of ordinary skill in the art.

Each component of the data lake 130 can perform certain processing of the raw network traffic data and/or other data (e.g., host data, process data, user data, out-of-band data or third party data) to transform the raw data to a form useable by the elastic processing engines 150. In some embodiments, the data lake 130 can include repositories for flow attributes 132, host and/or endpoint attributes 134, process attributes 136, and policy attributes 138. In some embodiments, the data lake 130 can also include repositories for VM or container attributes, application attributes, tenant attributes, network topology, application dependency maps, cluster attributes, etc.

The flow attributes 132 relate to information about flows traversing the network. A flow is generally one or more packets sharing certain attributes that are sent within a network within a specified period of time. The flow attributes 132 can include packet header fields such as a source address (e.g., Internet Protocol (IP) address, Media Access Control (MAC) address, Domain Name System (DNS) name, or other network address), source port, destination address, destination port, protocol type, class of service, among other fields. The source address can correspond to a first endpoint (e.g., network device, physical server, virtual partition, etc.) of the network, and the destination address can correspond to a second endpoint, a multicast group, or a broadcast domain. The flow attributes 132 can also include aggregate packet data such as flow start time, flow end time, number of packets for a flow, number of bytes for a flow, the union of TCP flags for a flow, among other flow data.

The host and/or endpoint attributes 134 describe host and/or endpoint data for each flow, and can include host and/or endpoint name, network address, operating system, CPU usage, network usage, disk space, ports, logged users, scheduled jobs, open files, and information regarding files and/or directories stored on a host and/or endpoint (e.g., presence, absence, or modifications of log files, configuration files, device special files, or protected electronic information). As discussed, in some embodiments, the host and/or endpoints attributes 134 can also include the out-of-band data 114 regarding hosts such as power level, temperature, and physical location (e.g., room, row, rack, cage door position, etc.) or the third party data 116 such as whether a host and/or endpoint is on an IP watch list or otherwise associated with a security threat, Whois data, or geocoordinates. In some embodiments, the out-of-band data 114 and the third party data 116 can be associated by process, user, flow, or other more granular or less granular network element or network communication.

The process attributes 136 relate to process data corresponding to each flow, and can include process name (e.g., bash, httpd, netstat, etc.), ID, parent process ID, path (e.g., /usr2/username/bin/, /usr/local/bin, /usr/bin, etc.), CPU utilization, memory utilization, memory address, scheduling information, nice value, flags, priority, status, start time, terminal type, CPU time taken by the process, the command that started the process, and information regarding a process owner (e.g., user name, ID, user's real name, e-mail address, user's groups, terminal information, login time, expiration date of login, idle time, and information regarding files and/or directories of the user).

The policy attributes 138 contain information relating to network policies. Policies establish whether a particular flow is allowed or denied by the network as well as a specific route by which a packet traverses the network. Policies can also be used to mark packets so that certain kinds of traffic receive differentiated service when used in combination with queuing techniques such as those based on priority, fairness, weighted fairness, token bucket, random early detection, round robin, among others. The policy attributes 138 can include policy statistics such as a number of times a policy was enforced or a number of times a policy was not enforced. The policy attributes 138 can also include associations with network traffic data. For example, flows found to be non-conformant can be linked or tagged with corresponding policies to assist in the investigation of non-conformance.

The analytics engine 110 can include any number of engines 150, including for example, a flow engine 152 for identifying flows (e.g., flow engine 152) or an attacks engine 154 for identify attacks to the network. In some embodiments, the analytics engine can include a separate distributed denial of service (DDoS) attack engine 155 for specifically detecting DDoS attacks. In other embodiments, a DDoS attack engine can be a component or a sub-engine of a general attacks engine. In some embodiments, the attacks engine 154 and/or the DDoS engine 155 can use machine learning techniques to identify security threats to a network. For example, the attacks engine 154 and/or the DDoS engine 155 can be provided with examples of network states corresponding to an attack and network states corresponding to normal operation. The attacks engine 154 and/or the DDoS engine 155 can then analyze network traffic data to recognize when the network is under attack. In some embodiments, the network can operate within a trusted environment for a time to establish a baseline for normal network operation for the attacks engine 154 and/or the DDoS.

The analytics engine 110 can further include a search engine 156. The search engine 156 can be configured, for example to perform a structured search, an NLP (Natural Language Processing) search, or a visual search. Data can be provided to the engines from one or more processing components.

The analytics engine 110 can also include a policy engine 158 that manages network policy, including creating and/or importing policies, monitoring policy conformance and non-conformance, enforcing policy, simulating changes to policy or network elements affecting policy, among other policy-related tasks.

The ADM module 140 can determine dependencies of applications of the network. That is, particular patterns of traffic can correspond to an application, and the interconnectivity or dependencies of the application can be mapped to generate a graph for the application (i.e., an application dependency mapping). In this context, an application refers to a set of networking components that provides connectivity for a given set of workloads. For example, in a conventional three-tier architecture for a web application, first endpoints of the web tier, second endpoints of the application tier, and third endpoints of the data tier make up the web application. The ADM module 140 can receive input data from various repositories of the data lake 130 (e.g., the flow attributes 132, the host and/or endpoint attributes 134, the process attributes 136, etc.). The ADM module 140 can analyze the input data to determine that there is first traffic flowing between external endpoints on port 80 of the first endpoints corresponding to Hypertext Transfer Protocol (HTTP) requests and responses. The input data can also indicate second traffic between first ports of the first endpoints and second ports of the second endpoints corresponding to application server requests and responses and third traffic flowing between third ports of the second endpoints and fourth ports of the third endpoints corresponding to database requests and responses. The ADM module 140 can define an ADM for the web application as a three-tier application including a first EPG comprising the first endpoints, a second EPG comprising the second endpoints, and a third EPG comprising the third endpoints.

The presentation module 116 can include an application programming interface (API) or command line interface (CLI) 160, a security information and event management (STEM) interface 162, and a web front-end 164. As the analytics engine 110 processes network traffic and corresponding data and generates analytics data, the analytics data may not be in a human-readable form or it can be too voluminous for a user to navigate. The presentation module 116 can take the analytics data generated by analytics engine 110 and further summarize, filter, and organize the analytics data as well as create intuitive presentations for the analytics data.

In some embodiments, the API or CLI 160 can be implemented using Hadoop® Hive from Apache® for the back end, and Java® Database Connectivity (JDBC) from Oracle® Corporation of Redwood Shores, Calif., as an API layer. Hive is a data warehouse infrastructure that provides data summarization and ad hoc querying. Hive provides a mechanism to query data using a variation of structured query language (SQL) that is called HiveQL. JDBC is an API for the programming language Java®, which defines how a client can access a database.

In some embodiments, the SIEM interface 162 can be implemented using Hadoop® Kafka for the back end, and software provided by Splunk®, Inc. of San Francisco, Calif. as the SIEM platform. Kafka is a distributed messaging system that is partitioned and replicated. Kafka uses the concept of topics. Topics are feeds of messages in specific categories. In some embodiments, Kafka can take raw packet captures and telemetry information from the data mover 108 as input, and output messages to a SIEM platform, such as Splunk®. The Splunk® platform is utilized for searching, monitoring, and analyzing machine-generated data.

In some embodiments, the web front-end 164 can be implemented using software provided by MongoDB®, Inc. of New York, N.Y. and Hadoop® ElasticSearch from Apache® for the back-end, and Ruby on Rails™ as the web application framework. MongoDB® is a document-oriented NoSQL database based on documents in the form of JavaScript® Object Notation (JSON) with dynamic schemas. ElasticSearch is a scalable and real-time search and analytics engine that provides domain-specific language (DSL) full querying based on JSON. Ruby on Rails™ is model-view-controller (MVC) framework that provides default structures for a database, a web service, and web pages. Ruby on Rails™ relies on web standards such as JSON or extensible markup language (XML) for data transfer, and hypertext markup language (HTML), cascading style sheets, (CSS), and JavaScript® for display and user interfacing.

Although FIG. 1 illustrates an example configuration of the various components of a network traffic monitoring system, those of skill in the art will understand that the components of the network traffic monitoring system 100 or any system described herein can be configured in a number of different ways and can include any other type and number of components. For example, the sensors 104, the collectors 106, the data mover 108, and the data lake 130 can belong to one hardware and/or software module or multiple separate modules. Other modules can also be combined into fewer components and/or further divided into more components.

FIG. 2 illustrates an example of a network environment 200 in accordance with an embodiment. In some embodiments, a network traffic monitoring system, such as the network traffic monitoring system 100 of FIG. 1, can be implemented in the network environment 200. It should be understood that, for the network environment 200 and any environment discussed herein, there can be additional or fewer nodes, devices, links, networks, or components in similar or alternative configurations. Embodiments with different numbers and/or types of clients, networks, nodes, cloud components, servers, software components, devices, virtual or physical resources, configurations, topologies, services, appliances, deployments, or network devices are also contemplated herein. Further, the network environment 200 can include any number or type of resources, which can be accessed and utilized by clients or tenants. The illustrations and examples provided herein are for clarity and simplicity.

The network environment 200 can include a network fabric 202, a Layer 2 (L2) network 204, a Layer 3 (L3) network 206, and servers 208a, 208b, 208c, 208d, and 208e (collectively, 208). The network fabric 202 can include spine switches 210a, 210b, 210c, and 210d (collectively, “210”) and leaf switches 212a, 212b, 212c, 212d, and 212e (collectively, “212”). The spine switches 210 can connect to the leaf switches 212 in the network fabric 202. The leaf switches 212 can include access ports (or non-fabric ports) and fabric ports. The fabric ports can provide uplinks to the spine switches 210, while the access ports can provide connectivity to endpoints (e.g., the servers 208), internal networks (e.g., the L2 network 204), or external networks (e.g., the L3 network 206).

The leaf switches 212 can reside at the edge of the network fabric 202, and can thus represent the physical network edge. For instance, in some embodiments, the leaf switches 212d and 212e operate as border leaf switches in communication with edge devices 214 located in the external network 206. The border leaf switches 212d and 212e can be used to connect any type of external network device, service (e.g., firewall, deep packet inspector, traffic monitor, load balancer, etc.), or network (e.g., the L3 network 206) to the fabric 202.

Although the network fabric 202 is illustrated and described herein as an example leaf-spine architecture, one of ordinary skill in the art will readily recognize that various embodiments can be implemented based on any network topology, including any datacenter or cloud network fabric. Indeed, other architectures, designs, infrastructures, and variations are contemplated herein. For example, the principles disclosed herein are applicable to topologies including three-tier (including core, aggregation, and access levels), fat tree, mesh, bus, hub and spoke, etc. Thus, in some embodiments, the leaf switches 212 can be top-of-rack switches configured according to a top-of-rack architecture. In other embodiments, the leaf switches 212 can be aggregation switches in any particular topology, such as end-of-row or middle-of-row topologies. In some embodiments, the leaf switches 212 can also be implemented using aggregation switches.

Moreover, the topology illustrated in FIG. 2 and described herein is readily scalable and can accommodate a large number of components, as well as more complicated arrangements and configurations. For example, the network can include any number of fabrics 202, which can be geographically dispersed or located in the same geographic area. Thus, network nodes can be used in any suitable network topology, which can include any number of servers, virtual machines or containers, switches, routers, appliances, controllers, gateways, or other nodes interconnected to form a large and complex network. Nodes can be coupled to other nodes or networks through one or more interfaces employing any suitable wired or wireless connection, which provides a viable pathway for electronic communications.

Network communications in the network fabric 202 can flow through the leaf switches 212. In some embodiments, the leaf switches 212 can provide endpoints (e.g., the servers 208), internal networks (e.g., the L2 network 204), or external networks (e.g., the L3 network 206) access to the network fabric 202, and can connect the leaf switches 212 to each other. In some embodiments, the leaf switches 212 can connect endpoint groups (EPGs) to the network fabric 202, internal networks (e.g., the L2 network 204), and/or any external networks (e.g., the L3 network 206). EPGs are groupings of applications, or application components, and tiers for implementing forwarding and policy logic. EPGs can allow for separation of network policy, security, and forwarding from addressing by using logical application boundaries. EPGs can be used in the network environment 200 for mapping applications in the network. For example, EPGs can comprise a grouping of endpoints in the network indicating connectivity and policy for applications.

As discussed, the servers 208 can connect to the network fabric 202 via the leaf switches 212. For example, the servers 208a and 208b can connect directly to the leaf switches 212a and 212b, which can connect the servers 208a and 208b to the network fabric 202 and/or any of the other leaf switches. The servers 208c and 208d can connect to the leaf switches 212b and 212c via the L2 network 204. The servers 208c and 208d and the L2 network 204 make up a local area network (LAN). LANs can connect nodes over dedicated private communications links located in the same general physical location, such as a building or campus.

The WAN 206 can connect to the leaf switches 212d or 212e via the L3 network 206. WANs can connect geographically dispersed nodes over long-distance communications links, such as common carrier telephone lines, optical light paths, synchronous optical networks (SONET), or synchronous digital hierarchy (SDH) links. LANs and WANs can include L2 and/or L3 networks and endpoints.

The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol can refer to a set of rules defining how the nodes interact with each other. Computer networks can be further interconnected by an intermediate network node, such as a router, to extend the effective size of each network. The endpoints 208 can include any communication device or component, such as a computer, server, blade, hypervisor, virtual machine, container, process (e.g., running on a virtual machine), switch, router, gateway, host, device, external network, etc.

In some embodiments, the network environment 200 also includes a network controller running on the host 208a. The network controller is implemented using the Application Policy Infrastructure Controller (APIC™) from Cisco®. The APIC™ provides a centralized point of automation and management, policy programming, application deployment, and health monitoring for the fabric 202. In some embodiments, the APIC™ is operated as a replicated synchronized clustered controller. In other embodiments, other configurations or software-defined networking (SDN) platforms can be utilized for managing the fabric 202.

In some embodiments, a physical server 208 can have instantiated thereon a hypervisor 216 for creating and running one or more virtual switches (not shown) and one or more virtual machines 218, as shown for the host 208b. In other embodiments, physical servers can run a shared kernel for hosting containers. In yet other embodiments, the physical server 208 can run other software for supporting other virtual partitioning approaches. Networks in accordance with various embodiments can include any number of physical servers hosting any number of virtual machines, containers, or other virtual partitions. Hosts can also comprise blade/physical servers without virtual machines, containers, or other virtual partitions, such as the servers 208a, 208c, 208d, and 208e.

The network environment 200 can also integrate a network traffic monitoring system, such as the network traffic monitoring system 100 shown in FIG. 1. For example, the network traffic monitoring system of FIG. 2 includes sensors 220a, 220b, 220c, and 220d (collectively, “220”), collectors 222, and an analytics engine, such as the analytics engine 110 of FIG. 1, executing on the server 208e. The analytics engine 208e can receive and process network traffic data collected by the collectors 222 and detected by the sensors 220 placed on nodes located throughout the network environment 200. Although the analytics engine 208e is shown to be a standalone network appliance in FIG. 2, it will be appreciated that the analytics engine 208e can also be implemented as a virtual partition (e.g., VM or container) that can be distributed onto a host or cluster of hosts, software as a service (SaaS), or other suitable method of distribution. In some embodiments, the sensors 220 run on the leaf switches 212 (e.g., the sensor 220a), the hosts 208 (e.g., the sensor 220b), the hypervisor 216 (e.g., the sensor 220c), and the VMs 218 (e.g., the sensor 220d). In other embodiments, the sensors 220 can also run on the spine switches 210, virtual switches, service appliances (e.g., firewall, deep packet inspector, traffic monitor, load balancer, etc.) and in between network elements. In some embodiments, sensors 220 can be located at each (or nearly every) network component to capture granular packet statistics and data at each hop of data transmission. In other embodiments, the sensors 220 may not be installed in all components or portions of the network (e.g., shared hosting environment in which customers have exclusive control of some virtual machines).

As shown in FIG. 2, a host can include multiple sensors 220 running on the host (e.g., the host sensor 220b) and various components of the host (e.g., the hypervisor sensor 220c and the VM sensor 220d) so that all (or substantially all) packets traversing the network environment 200 can be monitored. For example, if one of the VMs 218 running on the host 208b receives a first packet from the WAN 206, the first packet can pass through the border leaf switch 212d, the spine switch 210b, the leaf switch 212b, the host 208b, the hypervisor 216, and the VM. Since all or nearly all of these components contain a respective sensor, the first packet will likely be identified and reported to one of the collectors 222. As another example, if a second packet is transmitted from one of the VMs 218 running on the host 208b to the host 208d, sensors installed along the data path, such as at the VM 218, the hypervisor 216, the host 208b, the leaf switch 212b, and the host 208d will likely result in capture of metadata from the second packet.

The network traffic monitoring system 100 shown in FIG. 1 can be used to gather network traffic data and generate analytics for nodes and clusters of nodes on a per-network basis. Specifically, the network traffic monitoring system 100 can gather network traffic data and generate analytics for nodes within a single network, e.g. at a single datacenter.

Current network traffic monitoring systems are not implemented with systems or otherwise configured to provide users access to all gathered network traffic data and analytics generated from the gathered network traffic data. In particular, current network traffic monitoring systems are configured to, or implemented with systems configured to, provide users limited insights into a network. For example, current network traffic monitoring systems can only present to a user policy failures in a network while refraining from exposing the data used to identify the policy failures within the network to the user. As a result, users are unable to gain additional insights into a network that gathered network traffic data and generated analytics is capable of providing. Further, users are unable to manipulate or otherwise use gathered network traffic data and analytics in manners that fit their own needs.

Additionally, current network traffic monitoring systems are not implemented with systems or otherwise configured to work in conjunction with external data. In particular, gathered network traffic data and generated analytics are viewed and analyzed in a closed system without external data. For example, network traffic data can be analyzed by itself to discover servers communicating with a network without regard as to whether the servers are on a blacklist. This leads to deficiencies in realizing insights into a network that the collected data and generated analytics can provide when correlated and analyzed with external data. Additionally, this leads to deficiencies in realizing increased levels of control of the network that the collected data and generated analytics can provide when correlated and analyzed with external data.

FIG. 3 depicts a diagram of an example network traffic data user access system 300. The network traffic data user access system 300 can provide a user access to either or both network traffic data and analytics generated from the network traffic data. More specifically, the network traffic data user access system 300 can provide a user access to network traffic data collected by the network traffic monitoring system 100 and/or analytics generated from the network traffic data by the network traffic monitoring system 100. The network traffic data user access system 300 can be implemented within a network of a cluster of nodes, potentially as part of the network traffic monitoring system 100. Additionally, the network traffic data user access system 300 can be implemented remote from a cluster of nodes, e.g. in the cloud, and receive network traffic data and analytics from the network traffic monitoring system 100.

The example network traffic data user access system 300 shown in FIG. 3 includes a user access communicator 302, an external data collector 304, an external data correlator 306, and a correlated data storage 308. The user access communicator 302 can provide a user access to either or both network traffic data and analytics generated from the network traffic data. While the term user is utilized consistently throughout this paper, a user can refer to a larger organization or group, such as a tenant, a customer, or a group within a tenant. For example, a tenant can access definitions used to create application dependency mappings for applications in a datacenter of the tenant through the user access communicator 302. The user access communicator 302 can expose or otherwise allow a user to access either or both network traffic data and analytics generated from the network traffic data using an applicable API, such as a representation state transfer (hereinafter referred to as “REST”) API.

The user access communicator 302 can receive either or both network traffic data and analytics from the network traffic monitoring system 100. More specifically, the user access communicator 302 can receive network traffic data and analytics from the network traffic monitoring system 100 in real-time as either or both the network traffic data is gathered and the analytics are generate using the network traffic data. Upon receipt of network traffic data and analytics from the network traffic monitoring system 100, the user access communicator 302 can expose or provide the network traffic data and the analytics to a user. For example, the user access communicator 302 can provide a tenant real-time access to data flows as they are collected for a cluster of nodes of the tenant.

By providing user access to network traffic data and analytics, the user access communicator 302 can provide a platform through which a user can gain greater insight into a monitored network or datacenter. For example, a customer can view application definitions used to create an application dependency mapping and subsequently adjust the application definitions to create a more accurate application dependency mapping. Additionally, in accessing network traffic data and analytics, a user can customize how the data and analytics are manipulated or otherwise processed to fit their own needs, e.g. potentially for use in controlling operation of a network or datacenter. For example, a customer can use network traffic data to develop an application that automatically performs load balancing across servers based on the network traffic data.

Returning to the example network traffic data user access system 300 shown in FIG. 3, the external data collector 304 can collect external data for use in correlating the external data with either or both network traffic data and analytics. External data includes applicable data outside of network traffic data gathered by the network traffic monitoring system 100 and analytics generated from the gathered network traffic data. For example, external data can include proprietary data of a tenant whose datacenter is monitored using network traffic data gathered by the network traffic monitoring system 100. The external data collector 304 can collect external data through an applicable API, e.g. an API of a customer.

External data collected by the external data collector 304 can include third party data separate from a user or tenant associated with network traffic data gathered by the network traffic monitoring system 100 and analytics generated from the gathered network traffic data. For example, external data can include vendor data, e.g. AppDyanmics® data, New Relic® data, SalesForce® data, Seibel® data, NetScaler® data, Kafka® data, and ActiveMQ® data. Additionally, external data can include crowd sourced data independent of a tenant that network traffic data is gathered for by the network traffic monitoring system 100. The external data collector 304 can collect third party data as part of collecting external data through a third party API. For example, the external data collector 304 can collect data from Symantec® through a Symantec® API.

External data collected by the external data collector 304 can include security threat data, e.g. threat signals from security data sources and blacklists. Threat signals from security data sources, e.g. a third party source, can include identifications of nodes or applications that are a security risk or are under threat. Blacklists can include identifiers of data sources or servers in a network that are security risks or are potential security risks. Blacklists gathered by the external data collector 304 can include blacklists maintained by users or tenants. Additionally, blacklists gathered by the external data collector 304 can include blacklists maintained by a third party. Further, blacklists gathered by the external data collector 304 can include crowdsourced blacklists. For example, the external data collector 304 can collect crowdsourced blacklists from a third party, e.g. ZeuS Tracker blacklists.

Additionally, external data collected by the external data collector 304 can include server load data. Server load data can indicate an amount of computational work performed by a specific amount of computational resources of a server, e.g. in a datacenter of a tenant or customer. Further, server load data can include a number of processes in a queue waiting to access resources provided by a server. Server load data collected by the external data collector 304 can be collected from a third party system or application. For example, server load data for servers in a datacenter of a tenant can be collected from a Nagios® system

External data collected by the external data collector 304 can include malware port data. Malware port data can include identifications of ports vulnerable to malware. For example, malware port data can include one or a combination of an IP address of a host associated with a known malware vulnerable port, a protocol communication type associated with a known malware vulnerable port, and a port number of a known malware vulnerable port.

Further, external data collected by the external data collector 304 can include virtual private network (hereinafter referred to as “VPN”) log data or network access log data, e.g. as part of machine inventory data. Network access log data can include applicable log information for a network. For example, network access logs can include an identification of a user who accessed a network and a time the user accessed the network. In another example, network access logs can indicate resources utilized by a user as part of accessing a network. Virtual private network logs can include applicable log information of a VPN. For example, VPN log data can include an IP address or another unique identifier of a user and a time or instance when the user utilized a VPN to gain access to network resources, e.g. applications in a datacenter. VPN logs included as part of gathered external data can include usage logs and connection logs. For example, VPN logs can include usage logs indicating activity of users, e.g. applications accessed by the users and resources utilize by users through a VPN.

External data collected by the external data collector 304 can include file system, e.g. a cloud-based file system, audit log data. File system audit logs can include identifications of specific users and files in a file system accessed, created, or modified by the user. For example, file system audit logs can specify that a specific user accessed one or a plurality of documents within a file system. File system audit logs can include time stamps indicating when users accessed specific files in a file system.

Returning back to the example network traffic data user access system 300 shown in FIG. 3, the external data correlator 306 can correlate external data collected by the external data collector 304 with data received by or otherwise accessed through the user access communicator 302. Specifically, the external data correlator 306 can correlate either or both network traffic data collected by the network traffic monitoring system and analytics generated from the network traffic data with external data to create correlated data, otherwise referred to as correlated external analytics. Correlated data created by the external data correlator 306 can provide greater insights into a network, e.g. a datacenter. For example, the external data correlator 306 can correlate network flow data with external application or process data, e.g. UNIX ps command information, to provide a user with additional insights into a network, e.g. more insights into applications dependencies and performance within a network.

Correlated data generated by the external data correlator 306 can be utilized by users to develop their own applications, e.g. applications for use in controlling a network, based on the correlated data. For example, using network traffic flow data correlated with security threat data, a customer can develop an appliance to mitigate an impact of or warn of a DDoS attack. In another example, using network traffic flow data correlated with vendor data, a company can develop an application to rank groups within the company based on bandwidth usage, malware attack susceptibility, and security threat vulnerability. As a result, a customer can customize how they use correlated data, thereby allowing for greater and more customized control of networks.

The external data correlator 306 can correlate network traffic data and analytics with gathered external security threat data. For example, the external data correlator 306 can associate servers or data sources on a blacklist with traffic flows in a network, as indicated by network traffic flow data. In another example, the external data correlator 306 can associate nodes or applications under threat within a network, as can be indicated by a security threat signal received from a third party, with traffic flows in the network. As will be discussed in greater detail later, correlated external analytics created by correlating network traffic data and analytics with external security threat data can be used to control operation of a network.

Additionally, the external data correlator 306 can correlate network traffic data and analytics with gathered external server load data. For example, the external data correlator 306 can associate varying server loads with different traffic flows in a network, as indicated by network traffic flow data. As will be discussed in greater detail later, correlated external analytics created by correlating network traffic data and analytics with external server load data can be used to control operation of a network.

The external data correlator 306 can correlate network data and analytics with gathered external malware port data. For example, the external data correlator 306 can associate identifications of malware vulnerable ports with analytics generated for different traffic flows in a network, as indicated by network traffic flow data. As will be discussed in greater detail later, correlated external analytics created by correlating network traffic data and analytics with external malware port data can be used to control operation of a network.

Further, the external data correlator 306 can correlate network traffic data and analytics with gathered machine inventory data. Specifically, the external data correlator 306 can correlate network traffic data and analytics with either or both VPN logs and network access logs with different network traffic flows in a network, as indicated by network traffic flow data. As will be discussed in greater detail later, correlated external analytics created by correlating network traffic data and analytics with machine inventory data can be used to control operation of a network.

The external data correlator 306 can correlate network traffic data and analytics with file system audit log data. For example, the external data correlator 306 can correlate can associate files accessed by specific users in a file system, as indicated by file system audit logs, network traffic data to map or track the specific user accessing the file system. As will be discussed in greater detail later, correlated external analytics created by correlating network traffic data and analytics with file system audit log data can be used to control operation of a network.

The correlated data storage 308 can store correlated data. Specifically, the correlated data storage 308 can store correlated external analytics data created by the external data correlator 306 using external data collected by the external data collector 304 and data collected or otherwise accessed by the user access communicator 302. The user access communicator 302 can provide access to data stored in the correlated data storage 308. Specifically, the user access communicator 302 can allow a user to access correlated data stored in the correlated data storage 308. In turn, the user can use the correlated data to gain greater insight into a network, to further control and manage a network, and to potentially customize management of a network. For example, a customer can use the correlated data to develop and enforce security policies within a network.

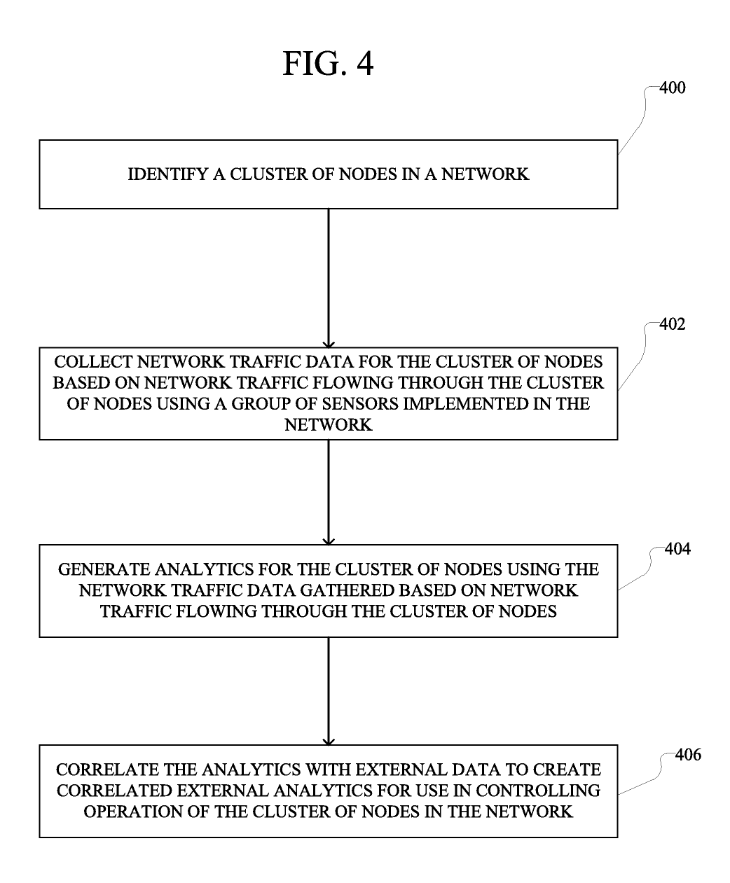

FIG. 4 illustrates a flowchart for an example method of correlating network traffic data and analytics with external data for use in controlling operation of a network. The method shown in FIG. 4 is provided by way of example, as there are a variety of ways to carry out the method. Additionally, while the example method is illustrated with a particular order of blocks, those of ordinary skill in the art will appreciate that FIG. 4 and the blocks shown therein can be executed in any order and can include fewer or more blocks than illustrated.

Each block shown in FIG. 4 represents one or more steps, processes, methods or routines in the method. For the sake of clarity and explanation purposes, the blocks in FIG. 4 are described with reference to the network traffic monitoring system 100 shown in FIG. 1 and the network traffic data user access system 300 shown in FIG. 3.

At step 400, the network traffic monitoring system 100 identifies a cluster of nodes in a network. The cluster of nodes can be identified based on whether concatenated feature vectors of the nodes exceed specified similarity thresholds. Additionally, the cluster of nodes can be identified based on whether either or both corresponding network-based feature vectors of the nodes are similar to a specific degree and corresponding process-based feature vectors are only a specific distance apart.

At step 402, the network traffic monitoring system 100 collects network traffic data for the cluster of nodes based on network traffic flowing through the cluster of nodes using a group of sensors implemented in the network. For example, network traffic data can indicate servers an endpoint is communicating with in providing network services. Network traffic data for the cluster of nodes can be gathered using sensors integrated as part of the network traffic monitoring system 100 in the first network. For example, network traffic data can be collected using sensors implemented at servers in the network.

At step 404, the network traffic monitoring system 100 generates analytics for the cluster of nodes using the network traffic data gathered based on the network traffic flowing through the cluster of nodes. Analytics generated by the network traffic monitoring system 100 can include one or a combination of discovered inventory, discovered applications, tags, application dependency mappings, network resource usages, application definitions, and sensor information for the cluster of nodes. The user access communicator 302 can expose either or both the network traffic data collected at step 402 and the analytics generated from the network traffic data at step 404.

At step 406, the external data correlator 306 correlates the analytics with external data to generate correlated external analytics, for use in controlling operation of the cluster of nodes in the network. For example, the analytics can be correlated with vendor data to identify network resource usage of the cluster of nodes by a group within an organization, for use in controlling network resource usage of the group. The analytics can be correlated with external data gathered by the external data collector 304. For example, the analytics can be correlated with vendor data of a customer gathered by the external data collector 304.

In correlating data, including the analytics, with external data, dependencies or associations between the data and external data can be created. For example, as part of correlating network traffic flows with external data, applications executed on behalf of a specific user can be associated with traffic flows occurring during execution of the applications. Additionally, in correlating network traffic flows and analytics with external data, causal relations between the flows, analytics, and external data can be created. For example, as part of correlating analytics with external data, predictive behavior of a specific user in accessing network services, e.g. traffic flows as a result of the user in accessing the network services, can be identified.

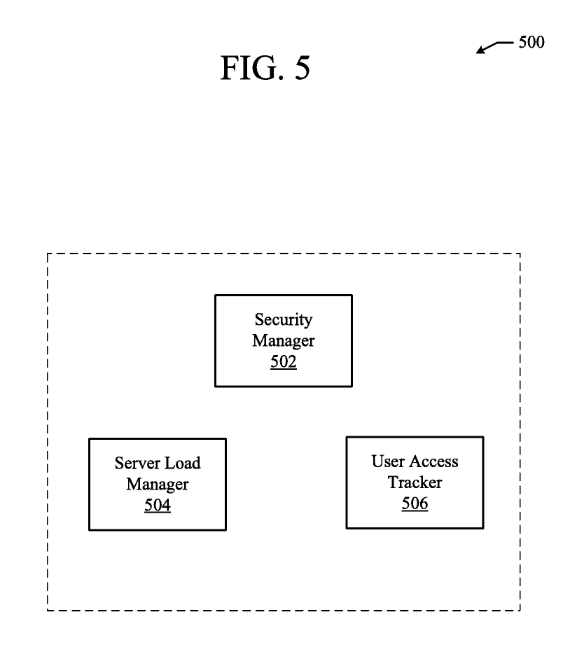

FIG. 5 depicts a diagram of an example network traffic-based network controller 500. The network traffic-based network controller 500 can be used to control operation of a network based on network traffic data gathered in the network. For example, the network traffic-based network controller 500 can control operation of a cluster of nodes in a network based on flows of data through the cluster of nodes, as part of the cluster of nodes providing access to network services. Additionally, the network traffic-based network controller 500 can control a network using analytics and network traffic data correlated with external data. For example, the network traffic-based network controller 500 can use analytics correlated with vendor data to develop and enforce policies specific to groups within a company.

The network traffic-based network controller 500 can be implemented as part of an application developed by a user. More specifically, a customer can use correlated external analytics to develop an application for controlling or aiding in control of a network that is implemented as part of the network traffic-based network controller 500. For example, a company can use correlated external analytics to generate an application, included as part of the network traffic-based network controller 500, for assigning a network threat index to groups within the company.

The example network traffic-based network controller 500 shown in FIG. 5 includes a security manager 502, a server load manager 504, and a user access tracker 506. The security manager 502 can manage security within a network based on correlated external analytics. The security manager can manage security within a network using an external blacklist, as included as part of external security threat data, correlated with either or both network traffic data and analytics generated from the network traffic data. In using correlated external analytics including a blacklist to control a network, the security manager 502 can automatically tag, e.g. in network traffic data, traffic flows including communications with servers or applications on the blacklist. Further, the security manager 502 can send out alerts based on communications with an application or server on a blacklist. For example, the security manager 502 can send out an alert to a network administrator if a host is contacted by a server on the blacklist.

Additionally, the security manager 502 can manage security within a network using an external security threat signal correlated with either or both network traffic data and analytics generated from the network traffic data. In using correlated external analytics including an external threat signal to control a network, the security manager 502 can automatically tag, e.g. in network traffic data, traffic flows flowing through an endpoint identified as a security threat by the external security threat signal. Further, the security manager 502 can send out alerts based on communications made by an endpoint deemed a security risk, as indicated by the external security threat signal.

The security manager 502 can use correlated external analytics including either or both blacklists and threat signals from security data sources to generate and/or enforce policies in a network. For example, the security manager 502 can define a policy to quarantine an endpoint attempting to communicate with a server on a blacklist, and subsequently enforce the policy within the network, e.g. using network traffic data. In another example, the secure manager 502 can define a policy to quarantine an endpoint indicated as a security risk by an external threat signal, and subsequently enforce the policy within the network, e.g. using network traffic data.

Further, the security manager 502 can segment security risks into groups based on vendor data correlated with either or both network traffic data and analytics generated from the network traffic data. For example, the security manager 502 can use correlated external analytics to identify a frequency at which different groups within a company are subjected to malware attacks. In another example, the security manager 502 can use correlated external analytics to identify how much different groups within a company are contributing to an overall security risk for a network.

The security manager 502 can manage security of a network using malware port data correlated with either or both network traffic data and analytics generated from the network traffic data. Using correlated external analytics including malware port data, the security manager 502 can assign a threat level or index to one or a combination of a server, an endpoint, a path within a network, and an application. For example, the security manager 502 can assign a threat level to an application based on a threat level of a machine the application is executing on. In another example, the security manager 502 can assign a threat level to an application based on a threat level of a machine supporting another application communicating with the application. An assigned threat level can subsequently be presented to a user for use in controlling operation of a network.

Referring back to the example network traffic-based network controller 500 shown in FIG. 5, the server load manager 504 can manage loads on servers within a network based on correlated external analytics. Specifically, the server load manager 504 can manage server loads using server load data correlated with either or both network traffic data and analytics generated from the network traffic data. For example, the server load manager can use correlated external analytics to determine when a load on a server is too high or has increased above a threshold amount. If the server load manager 504 determines a server load is too high, then the server load manager 504 can perform or cause performance of applicable mitigation steps to reduce the server load or otherwise limit its impact on network performance. Example, applicable mitigation steps include sending an alert to an administrator, enforcing a policy to stop sending traffic to a server, and sending an alert to a DDoS mitigation appliance or service provider.

Further, the server load manager 504 can segment network resource usage into groups based on vendor data correlated with either or both network traffic data and analytics generated from the network traffic data. For example, the server load manager 504 can use correlated external analytics including vendor data to identify an amount of bandwidth in a network each group within a company is using. The server load manager 504 can present indications of network resource usages by groups to a user for purposes of managing the network by the user. For example, based on network resource usage of a group, a network administrator can allocate more or less network resources to different groups.

Referring back to the example network traffic-based network controller 500 shown in FIG. 5, the user access tracker 506 tracks user access within a network for purposes of controlling the network based on correlated external analytics. The user access tracker 506 can use VPN log data and/or network access log data correlated with network traffic data and analytics created from the network traffic data to track a user in accessing network services. More specifically, the user access tracker 506 can use either or both VPN log data and network access log data to identify a source of a data leak from a network. For example, the user access tracker 506 can use correlated external analytics including VPN log data to identify when a user, e.g. IP address, accessed a network and/or applications accessed or executed on behalf of the user. Using an identification of when the user accessed the network and/or applications accessed by the user, a lineage from the user to a source of a data leak can be mapped in order to determine whether the user is the actual source of the data leak. Subsequently, a network can be controlled accordingly based on an identified source of a data leak. This is advantageous as users responsible for data leaks in a network are difficult to determine, as often users access applications, e.g. an application used to cause the data leak, as a headless user account or without an identification of the user.

Further, the user access tracker 506 can use VPN log data and/or network access log data correlated with network traffic data and analytics to determine resource utilization of a user. More specifically, the user access tracker 506 can utilize an identification of a user correlated with a server, e.g. network traffic data associated with the user utilizing the server, to determine resource utilization of the user. For example, the user access tracker 506 can use correlated external analytics to determine applications executed on behalf of a specific user, and an amount of bandwidth consumed by the user through execution of the applications on the user's behalf. Subsequently, resource utilization of a user in a network, as determined by the user access tracker 506, can be utilized to control the network. For example, a user's access to a network can be restricted or otherwise throttled if they are consuming too many resources.

The user access tracker 506 can use file system audit logs correlated with network traffic data and analytics to track users in accessing files through a file system, e.g. a cloud-based file system. More specifically, the user access tracker 506 can map different users to a file in a file system using file system audit logs and network traffic data generated through the user accessing the files through a network. Based on mappings of users to the file, the user access tracker 506 can create a history for the file indicating who accessed the file and/or who made modifications to the file. A history of the file, as created by the user access tracker and be used to control the file system implemented in a network, e.g. as part of controlling the network using correlated external analytics.

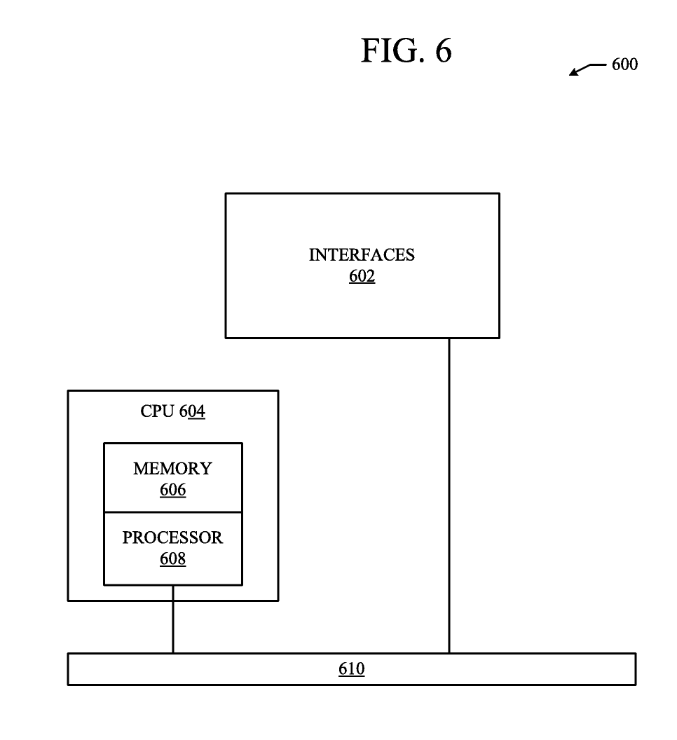

The disclosure now turns to FIGS. 6 and 7, which illustrate example network devices and computing devices, such as switches, routers, load balancers, client devices, and so forth.

FIG. 6 illustrates an example network device 600 suitable for performing switching, routing, load balancing, and other networking operations. Network device 600 includes a central processing unit (CPU) 604, interfaces 602, and a bus 610 (e.g., a PCI bus). When acting under the control of appropriate software or firmware, the CPU 604 is responsible for executing packet management, error detection, and/or routing functions. The CPU 604 preferably accomplishes all these functions under the control of software including an operating system and any appropriate applications software. CPU 604 may include one or more processors 608, such as a processor from the INTEL X86 family of microprocessors. In some cases, processor 608 can be specially designed hardware for controlling the operations of network device 600. In some cases, a memory 606 (e.g., non-volatile RAM, ROM, etc.) also forms part of CPU 604. However, there are many different ways in which memory could be coupled to the system.

The interfaces 602 are typically provided as modular interface cards (sometimes referred to as “line cards”). Generally, they control the sending and receiving of data packets over the network and sometimes support other peripherals used with the network device 600. Among the interfaces that may be provided are Ethernet interfaces, frame relay interfaces, cable interfaces, DSL interfaces, token ring interfaces, and the like. In addition, various very high-speed interfaces may be provided such as fast token ring interfaces, wireless interfaces, Ethernet interfaces, Gigabit Ethernet interfaces, ATM interfaces, HSSI interfaces, POS interfaces, FDDI interfaces, WIFI interfaces, 3G/4G/5G cellular interfaces, CAN BUS, LoRA, and the like. Generally, these interfaces may include ports appropriate for communication with the appropriate media. In some cases, they may also include an independent processor and, in some instances, volatile RAM. The independent processors may control such communications intensive tasks as packet switching, media control, signal processing, crypto processing, and management. By providing separate processors for the communications intensive tasks, these interfaces allow the master microprocessor 604 to efficiently perform routing computations, network diagnostics, security functions, etc.

Although the system shown in FIG. 6 is one specific network device of the present invention, it is by no means the only network device architecture on which the present invention can be implemented. For example, an architecture having a single processor that handles communications as well as routing computations, etc., is often used. Further, other types of interfaces and media could also be used with the network device 600.

Regardless of the network device's configuration, it may employ one or more memories or memory modules (including memory 606) configured to store program instructions for the general-purpose network operations and mechanisms for roaming, route optimization and routing functions described herein. The program instructions may control the operation of an operating system and/or one or more applications, for example. The memory or memories may also be configured to store tables such as mobility binding, registration, and association tables, etc. Memory 606 could also hold various software containers and virtualized execution environments and data.

The network device 600 can also include an application-specific integrated circuit (ASIC), which can be configured to perform routing and/or switching operations. The ASIC can communicate with other components in the network device 600 via the bus 610, to exchange data and signals and coordinate various types of operations by the network device 600, such as routing, switching, and/or data storage operations, for example.

FIG. 7 illustrates a computing system architecture 700 wherein the components of the system are in electrical communication with each other using a connection 705, such as a bus. Exemplary system 700 includes a processing unit (CPU or processor) 710 and a system connection 705 that couples various system components including the system memory 715, such as read only memory (ROM) 720 and random access memory (RAM) 725, to the processor 710. The system 700 can include a cache of high-speed memory connected directly with, in close proximity to, or integrated as part of the processor 710. The system 700 can copy data from the memory 715 and/or the storage device 730 to the cache 712 for quick access by the processor 710. In this way, the cache can provide a performance boost that avoids processor 710 delays while waiting for data. These and other modules can control or be configured to control the processor 710 to perform various actions. Other system memory 715 may be available for use as well. The memory 715 can include multiple different types of memory with different performance characteristics. The processor 710 can include any general purpose processor and a hardware or software service, such as service 1 732, service 2 734, and service 3 736 stored in storage device 730, configured to control the processor 710 as well as a special-purpose processor where software instructions are incorporated into the actual processor design. The processor 710 may be a completely self-contained computing system, containing multiple cores or processors, a bus, memory controller, cache, etc. A multi-core processor may be symmetric or asymmetric.

To enable user interaction with the computing device 700, an input device 745 can represent any number of input mechanisms, such as a microphone for speech, a touch-sensitive screen for gesture or graphical input, keyboard, mouse, motion input, speech and so forth. An output device 735 can also be one or more of a number of output mechanisms known to those of skill in the art. In some instances, multimodal systems can enable a user to provide multiple types of input to communicate with the computing device 700. The communications interface 740 can generally govern and manage the user input and system output. There is no restriction on operating on any particular hardware arrangement and therefore the basic features here may easily be substituted for improved hardware or firmware arrangements as they are developed.

Storage device 730 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 725, read only memory (ROM) 720, and hybrids thereof.

The storage device 730 can include services 732, 734, 736 for controlling the processor 710. Other hardware or software modules are contemplated. The storage device 730 can be connected to the system connection 705. In one aspect, a hardware module that performs a particular function can include the software component stored in a computer-readable medium in connection with the necessary hardware components, such as the processor 710, connection 705, output device 735, and so forth, to carry out the function.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Example described above with reference to the accompanying figures provide an improvement to one or more aspects of existing methods and systems for monitoring and controlling clusters of nodes in a network. Monitoring and controlling clusters of nodes in a network plays an important role in the technological field of network services. In particular, monitoring and controlling clusters of nodes in a network has become more challenging as networks grow in size and complexity and as cloud infrastructures are used in providing network services. Therefore, it is important to provide network administrators with additional and simplified functionalities for monitoring and controlling clusters of nodes in a network, hence providing an improvement to the performance of underlying computing devices and networks supported thereon as well as to the technological field of network services.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language reciting “at least one of” refers to at least one of a set and indicates that one member of the set or multiple members of the set satisfy the claim. For example, claim language reciting “at least one of A and B” means A, B, or A and B.

What is claimed is:

1. A method comprising:
identifying a cluster of nodes in a network;
collecting network traffic data for the cluster of nodes in the network based on network traffic flowing through the cluster of nodes using a group of sensors implemented in the network;
generating analytics for the cluster of nodes in the network using the collected network traffic data; and
correlating the analytics with external data to create correlated external analytics for use in controlling operation of the cluster of nodes in the network.

2. The method of claim 1, wherein the external data includes either or both customer data of a customer of the network and third party data.

3. The method of claim 1, wherein the correlated external analytics are utilized by a third party to develop an external application for controlling operation of the cluster of nodes in the network using one or a combination of the network traffic data for the cluster of nodes in the network, the analytics for the cluster of nodes in the network, and the correlated external analytics.

4. The method of claim 1, wherein the external data includes a blacklist, the method further comprising:
correlating the blacklist with the analytics to create the correlated external analytics using the blacklist; and
controlling operation of the cluster of nodes in the network using the correlated external analytics created using the blacklist.

5. The method of claim 4, wherein controlling operation of the cluster of nodes in the network using the correlated external analytics further comprises either or both generating and enforcing a policy that quarantines node in the cluster of nodes attempting to communicate with an object on the blacklist and tagging network traffic relating attempted communication with the object on the blacklist.

6. The method of claim 1, wherein the external data includes server load data of servers in the cluster of nodes in the network, the method further comprising:
correlating the server load data with the analytics to generate the correlated external analytics; and
managing the servers in the cluster of nodes in the network using correlated external analytics created with the server load data.

7. The method of claim 6, further comprising:
creating load balancing rules for controlling loads on the servers with respect to a specific service the cluster of nodes in the network are providing using the correlated external analytics generated with the server load data; and
managing the servers in the cluster of nodes in the network using the load balancing rules created using the correlated external analytics generated with the server load data.

8. The method of claim 1, further comprising identifying network usage statistics of the cluster of nodes in the network for subsets of a customer accessing services using the cluster of nodes based on the correlated external analytics.

9. The method of claim 1, wherein the external data includes a list of ports vulnerable to malware, the method further comprising:
correlating the list of ports vulnerable to malware with the analytics to create the correlated external analytics using the list of ports vulnerable to malware; and
assigning a threat index of malware vulnerability to nodes in the cluster of nodes using the correlated external analytics created using the list of ports vulnerable to malware.

10. The method of claim 1, wherein the external data includes user access logs to the network, the method further comprising:
correlating the user access logs to the network with the analytics to create the correlated external analytics using the user access logs; and
identifying a user associated with a data leak from the network using the correlated external analytics created using the user access logs.

11. The method of claim 10, further comprising:
generating a lineage of user node access of at least one user, including the user, accessing nodes in the cluster of nodes stemming from a source of the data leak in the nodes in the cluster of nodes from the correlated external analytics; and
identifying the user of the at least one user is associated with the data leak using the lineage of node access.

12. The method of claim 11, wherein the lineage of node access is created based on either or both a time of the data leak and a time the at least one user began accessing the network as indicated by the user access logs.

13. The method of claim 1, wherein the external data includes user access logs to the network, the method further comprising:
correlating the user access logs to the network with the analytics to create the correlated external analytics using the user access logs; and
identifying resource usage of users accessing network resources through the cluster of nodes in the network on a per user basis of the users through the correlated external analytics created using the user access logs.

14. The method of claim 1, wherein the external data includes audit logs of a cloud-based file system implemented through the cluster of nodes in the network, the method further comprising:
correlating the audit logs with the analytics to create the correlated external analytics using the audit logs; and
tracking network resource usage in accessing files through the cloud-based file system using the correlated external analytics created using the audit logs of the cloud-based file system.

15. A system comprising:
one or more processors; and
at least one computer-readable storage medium having stored therein instructions which, when executed by the one or more processors, cause the one or more processors to perform operations comprising:
identifying a cluster of nodes in a network;
collecting network traffic data for the cluster of nodes including host and endpoint data for the cluster of nodes based on network traffic flowing through the cluster of nodes using a group of sensors implemented in the network;
generating analytics for the cluster of nodes in the network using the collected network traffic data; and
correlating the analytics with external data to create correlated external analytics for use in controlling operation of the cluster of nodes in the network.

16. The system of claim 15, wherein the external data includes a blacklist and the instructions which, when executed by the one or more processors, further cause the one or more processors to perform operations comprising:
correlating the blacklist with the analytics to create the correlated external analytics using the blacklist; and
controlling operation of the cluster of nodes in the network using the correlated external analytics created using the blacklist.

17. The system of claim 15, wherein the external data includes server load data of servers in the cluster of nodes in the network and the instructions which, when executed by the one or more processors, further cause the one or more processors to perform operations comprising:
correlating the server load data with the analytics to generate the correlated external analytics; and
managing the servers in the cluster of nodes in the network using correlated external analytics created with the server load data.

18. The system of claim 15, wherein the external data includes user access logs to the network and the instructions which, when executed by the one or more processors, further cause the one or more processors to perform operations comprising:
correlating the user access logs to the network with the analytics to create the correlated external analytics using the user access logs; and
identifying a user associated with a data leak from the network using the correlated external analytics created using the user access logs.

19. The system of claim 15, wherein the external data includes audit logs of a cloud-based file system implemented through the cluster of nodes in the network and the instructions which, when executed by the one or more processors, further cause the one or more processors to perform operations comprising:
correlating the audit logs with the analytics to create the correlated external analytics using the audit logs; and
tracking network resource usage in accessing files through the cloud-based file system using the correlated external analytics created using the audit logs of the cloud-based file system.

20. A non-transitory computer-readable storage medium having stored therein instructions which, when executed by a processor, cause the processor to perform operations comprising:
identifying a cluster of nodes in a network;
collecting network traffic data for the cluster of nodes in the network based on network traffic flowing through the cluster of nodes using a group of sensors implemented in the network
generating analytics for the cluster of nodes in the network using the collected network traffic data; and
correlating the analytics with external data including a blacklist to create correlated external analytics for use in controlling operation of the cluster of nodes in the network.
